(19) United States
(12) Patent Application Publication
(10) Pub. No.: US 2018/0036901 A1
(43) Pub. Date: Feb. 8, 2018

(54) GUIDE BAR OF CHAIN SAW

(71) Applicant: SUEHIRO SEIKO KABUSHIKI KAISHA, Miki-shi, Hyogo (JP)

(72) Inventors: Toshihiro TSUMURA, Miki-shi (JP); Akihito YANOO, Miki-shi (JP); Taichi KADOWAKI, Miki-shi (JP); Toshihide UCHINO, Miki-shi (JP)

(21) Appl. No.: 15/553,971

(22) PCT Filed: Nov. 12, 2015
(86) PCT No.: PCT/JP2015/005663

§ 371 Date: Aug. 25, 2017

(30) Foreign Application Priority Data
Feb. 26, 2015 (JP) 2015-036353

(51) Int. Cl. B27B 17/02

(52) U.S. Cl. CPC B27B 17/025

(57) ABSTRACT

A guide bar of a chain saw according to the present invention includes: an elongated plate-shaped guide bar body that supports a saw chain on its peripheral edge portion; a plurality of elongated holes formed through the guide bar body and positioned at both sides of a region that has a predetermined width and includes a central axis line CL extending in a longitudinal direction of the guide bar body, such that the region is positioned between the elongated holes, which are elongated in the longitudinal direction; and a plurality of attachment members, each of which is pre-formed in such a shape as to seal up a corresponding one of the elongated holes and attached to the corresponding elongated hole.

### TECHNICAL FIELD

The present invention relates to a guide bar of a chain saw for use in, for example, felling and cutting of trees.

### BACKGROUND ART

Chain saws are operated by workers and used for, for example, felling and cutting of trees. Conventionally, it has been sought to reduce the weight of the guide bar of chain saws for the purpose of improving the usability of the chain saws for the workers (see Patent Literatures 1 to 4, for example).

In order to realize weight reduction of the guide bar, the guide bar is manufactured, for example, in the following manner: form a large number of recesses by cutting in both surfaces of the guide bar body, which is made of a metal plate; fill the recesses with a resin; and after the resin is cured, grind the resin surfaces to make the resin surfaces flush with the guide bar body.

### CITATION LIST

### Patent Literature

PTL 1: Japanese Utility Model Registration No. 2502986

PTL 2: Japanese Utility Model Registration No. 2502991

PTL 3: U.S. Pat. No. 4,837,934

PTL 4: U.S. Pat. No. 5,025,561

### SUMMARY OF INVENTION

### Technical Problem

However, in the above case, the cutting process for forming the large number of recesses takes a long time, and in addition, after the resin is cured, the resin surfaces need to be ground. For these reasons, the manufacturing time of the guide bar is long, and the manufacturing cost is high.

The present invention has been made to solve the above-described problems, and an object of the present invention is to provide a guide bar of a chain saw with a reduced weight, the guide bar making it possible to reduce its manufacturing time and manufacturing cost.

### Solution to Problem

In order to achieve the above-described object, a guide bar of a chain saw according to one embodiment of the present invention includes: an elongated plate-shaped guide bar body that supports a saw chain on its peripheral edge portion; a plurality of elongated holes formed through the guide bar body and positioned at both sides of a region that has a predetermined width and includes a central axis line extending in a longitudinal direction of the guide bar body, such that the region is positioned between the elongated holes, which are elongated in the longitudinal direction; and a plurality of attachment members, each of which is pre-formed in such a shape as to seal up a corresponding one of the elongated holes and attached to the corresponding elongated hole.

### Advantageous Effects of Invention

The present invention is configured as described above, and has an advantage of being able to provide a guide bar of a chain saw with a reduced weight, the guide bar making it possible to reduce its manufacturing time and manufacturing cost.

### BRIEF DESCRIPTION OF DRAWINGS

FIG. 1 is a front view showing one example of a guide bar of a chain saw according to one embodiment of the present invention.

FIG. 2A to FIG. 2E are each a sectional view showing one example of attachment members.

FIG. 3 is a sectional view showing one example of the attachment members.

FIG. 4 is a front view of an essential part of the guide bar, showing a first variation of a guide bar body.

FIG. 5A to FIG. 5E are each a sectional view showing one example of the attachment members when the guide bar body shown in FIG. 4 is used.

FIG. 6A to FIG. 6C are each a sectional view showing one example of the attachment members when the guide bar body shown in FIG. 4 is used.

FIG. 7 is a front view of an essential part of the guide bar, showing a second variation of the guide bar body.

FIG. 8 is a sectional view showing one example of the attachment members when the guide bar body shown in FIG. 7 is used.

FIG. 9 is a front view of an essential part of the guide bar, showing a third variation of the guide bar body.

FIG. 10 is a sectional view showing one example of the attachment members when the guide bar body shown in FIG. 9 is used.

FIG. 11 is a front view of an essential part of the guide bar, showing a fourth variation of the guide bar body.

FIG. 12 is a sectional view showing one example of the attachment members when the guide bar body shown in FIG. 11 is used.

FIG. 13 is a front view of the guide bar, showing a fifth variation of the guide bar body.

FIG. 14 is a front view of the guide bar, showing a sixth variation of the guide bar body.

### DESCRIPTION OF EMBODIMENTS

Hereinafter, one embodiment of the present disclosure is described with reference to the drawings.

The embodiment described below indicates specific examples of the present disclosure. Therefore, numerical values, shapes, materials, components, the arrangement and the manner of connection of the components, etc., indicated in the embodiment below are mere examples, and do not limit the scope of the present disclosure.

In the drawings, the same or corresponding components are denoted by the same reference signs, and repeating the same descriptions is avoided in some cases. The drawings show each component schematically in order to facilitate the understanding thereof. Therefore, in some cases, the drawings may not display precise shapes, dimensional ratios, etc.

### Embodiment

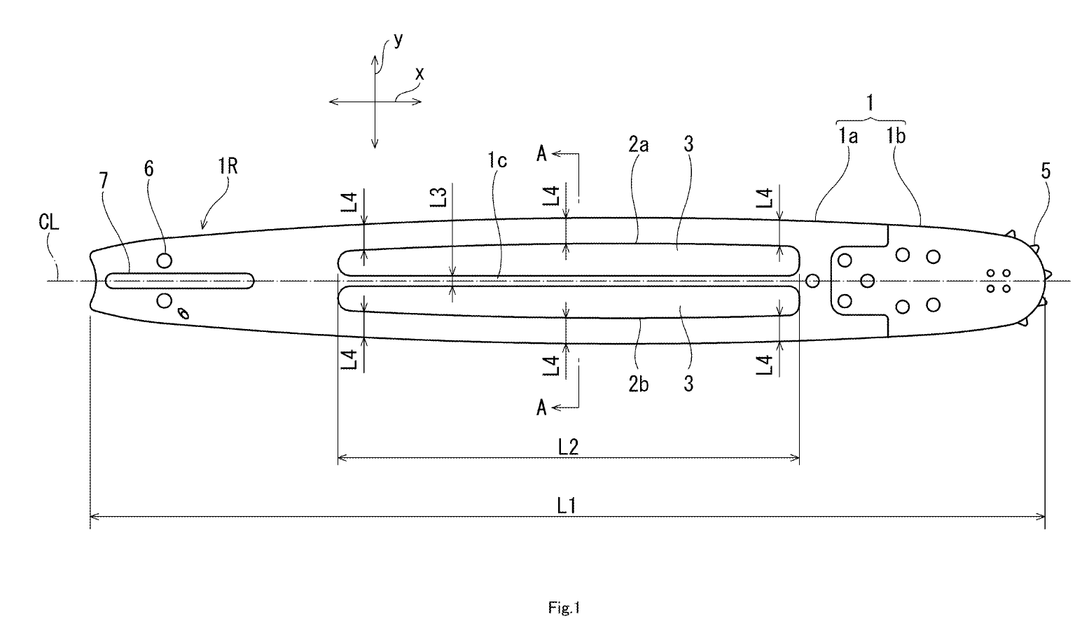

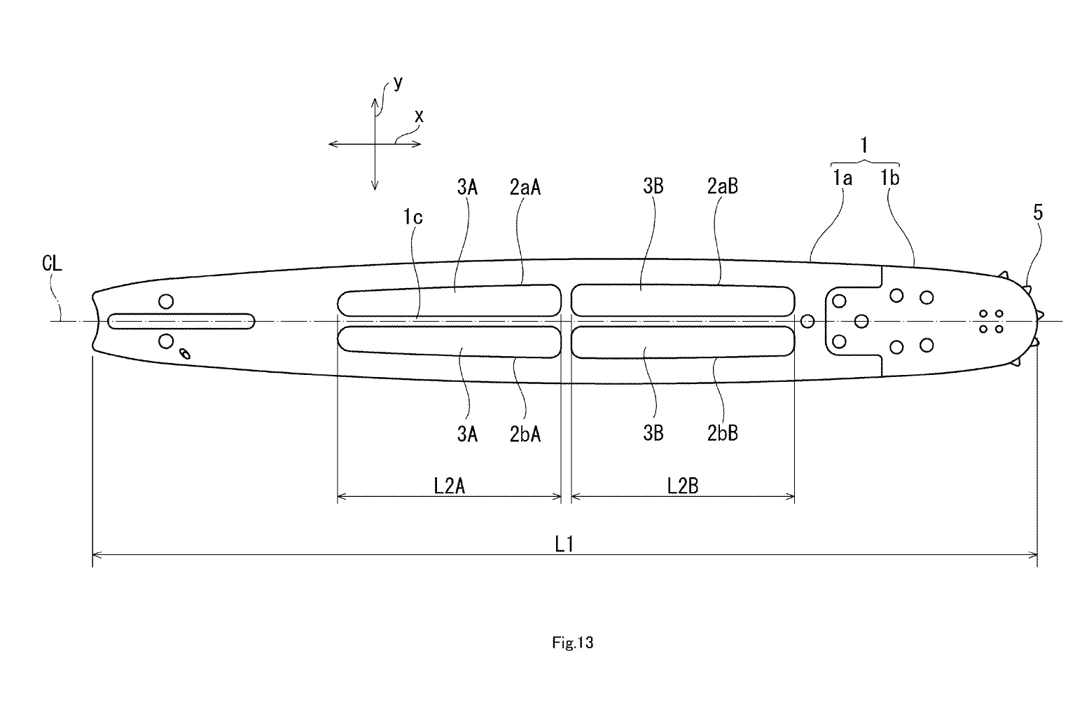

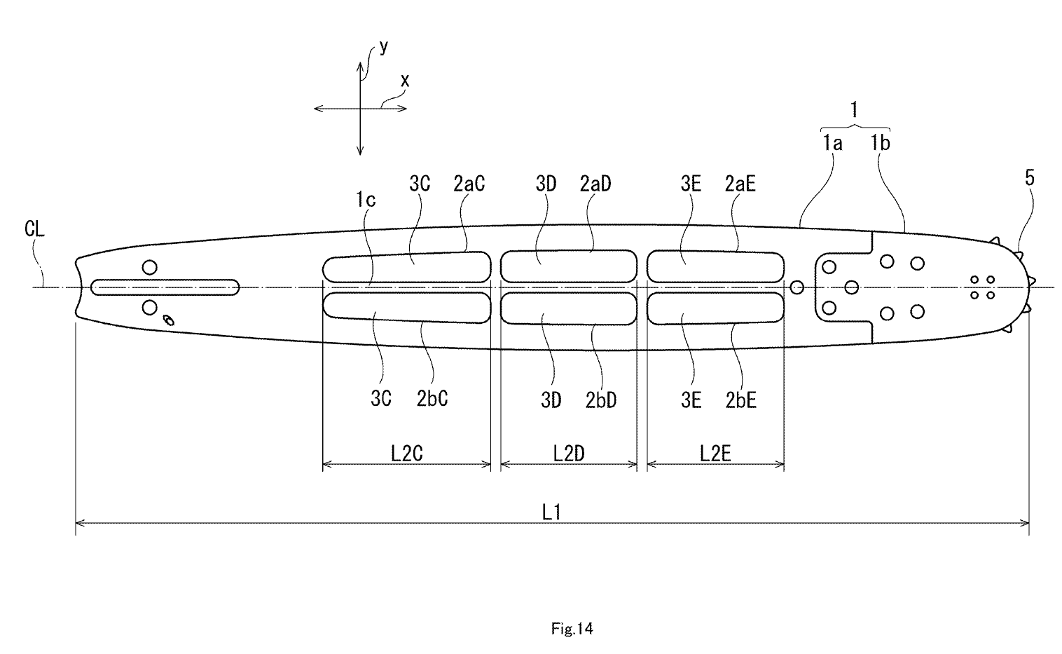

A guide bar of a chain saw according the present embodiment includes: an elongated plate-shaped guide bar body that supports a saw chain on its peripheral edge portion; a plurality of elongated holes formed through the guide bar body and positioned at both sides of a region that has a predetermined width and includes a central axis line extending in a longitudinal direction of the guide bar body, such that the region is positioned between the elongated holes, which are elongated in the longitudinal direction; and a plurality of attachment members, each of which is pre-formed in such a shape as to seal up a corresponding one of the elongated holes and attached to the corresponding elongated hole (see FIG. 1, FIG. 13, and FIG. 14, for example).

According to the above configuration, weight reduction can be realized by using light-weight components made of, for example, a resin as the attachment members. Regarding the number of elongated holes to be formed, it will suffice if, for example, one elongated hole is formed at each side of the region that has the predetermined width and includes the central axis line. In this case, the pre-formed attachment members are required to be attached to only two positions (i.e., two elongated holes). This makes it possible to reduce the manufacturing time and manufacturing cost.

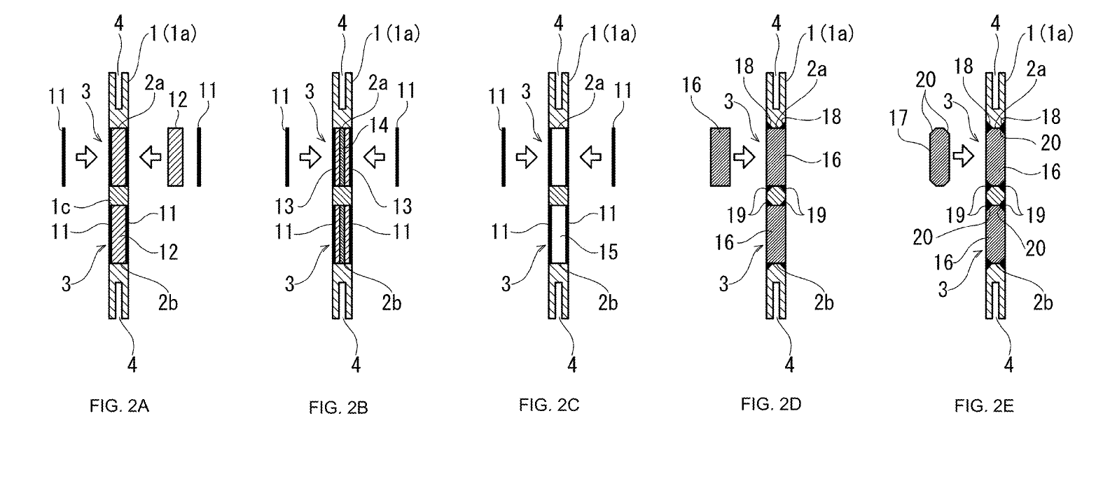

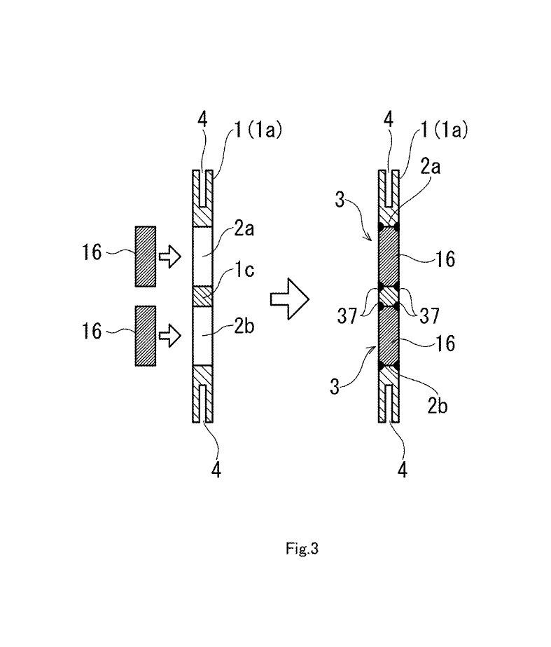

In the above guide bar, the attachment members may be fitted in the elongated holes, and each attachment member may be joined to opening edges of the corresponding elongated hole (see FIGS. 2A to 2E and FIG. 3, for example).

In the above guide bar, each attachment member may include two pieces of sheet metal that are disposed at both ends of the corresponding elongated hole in a thickness direction of the guide bar body. The two pieces of sheet metal and the opening edges of the elongated hole may be joined together by welding (see FIGS. 2A to 2C, for example).

In the above guide bar, each attachment member may further include one or more components disposed between the two pieces of sheet metal, the one or more components each having a shape that is the same as a cross-sectional shape of the corresponding elongated hole (see FIGS. 2A and 2B, for example).

In the above guide bar, chamfered portions may be: formed on portions of each attachment member, the portions contacting the opening edges of the corresponding elongated hole; and/or formed on the opening edges of the elongated hole. Each attachment member and the opening edges of the corresponding elongated hole may be joined together by filling the chamfered portions with an adhesive (see FIGS. 2D and 2E, for example).

In the above guide bar, each attachment member may be formed by a single component having a shape that is the same as a cross-sectional shape of the corresponding elongated hole. The single component may be fitted in the elongated hole, and the single component and the opening edges of the elongated hole may be joined together by laser welding (see FIG. 3, for example).

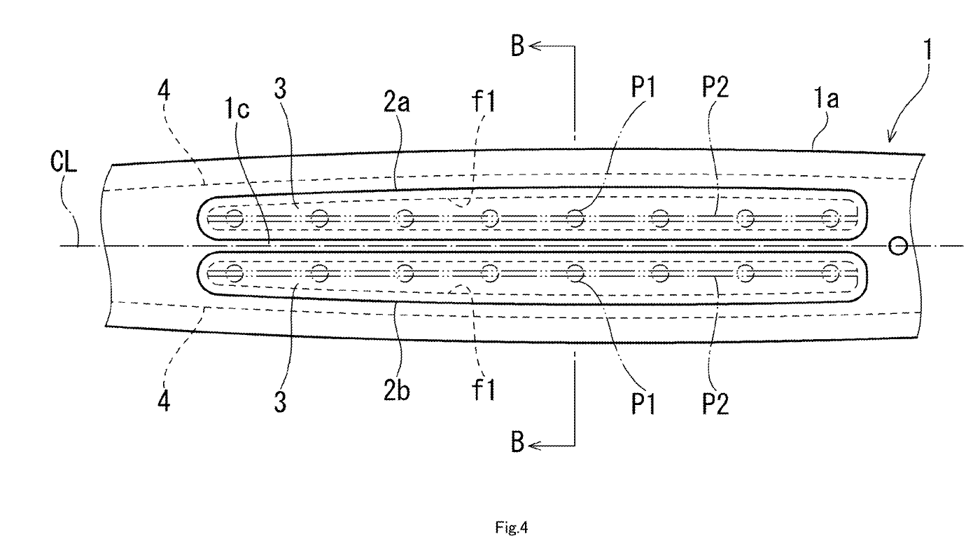

In the above guide bar, the guide bar body may include sandwiched portions, each of which is formed by either a projecting portion or a beam portion, the projecting portion extending inward from a side wall of each elongated hole, the beam portion connecting between opposite parts of the side wall of the elongated hole. Each attachment member may include first and second components, between which a corresponding one of the sandwiched portions is sandwiched from both sides (see FIGS. 4 to 12, for example).

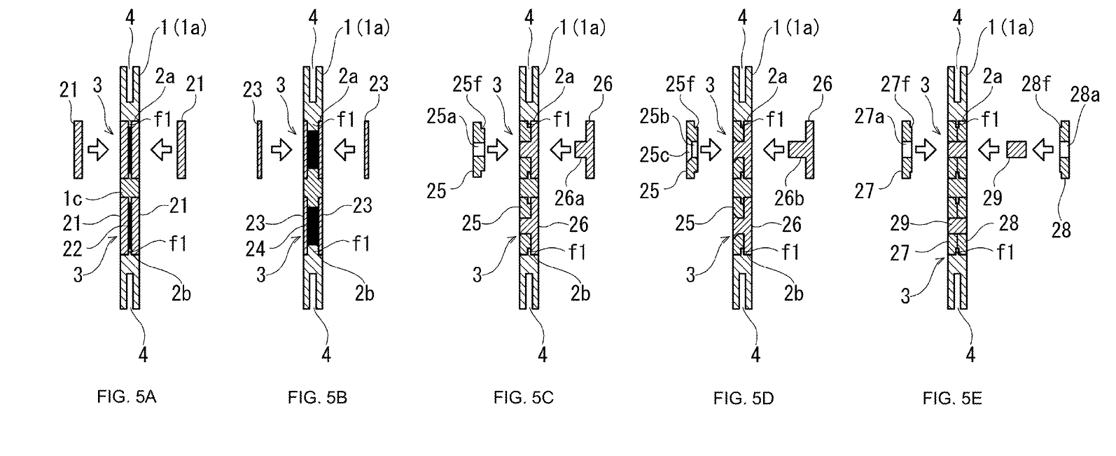

In the above guide bar, surfaces of the first and second components, the surfaces contacting the corresponding sandwiched portion, may be flat, and a gap between the first and second components may be filled with an adhesive (see FIGS. 5A and 5B, for example).

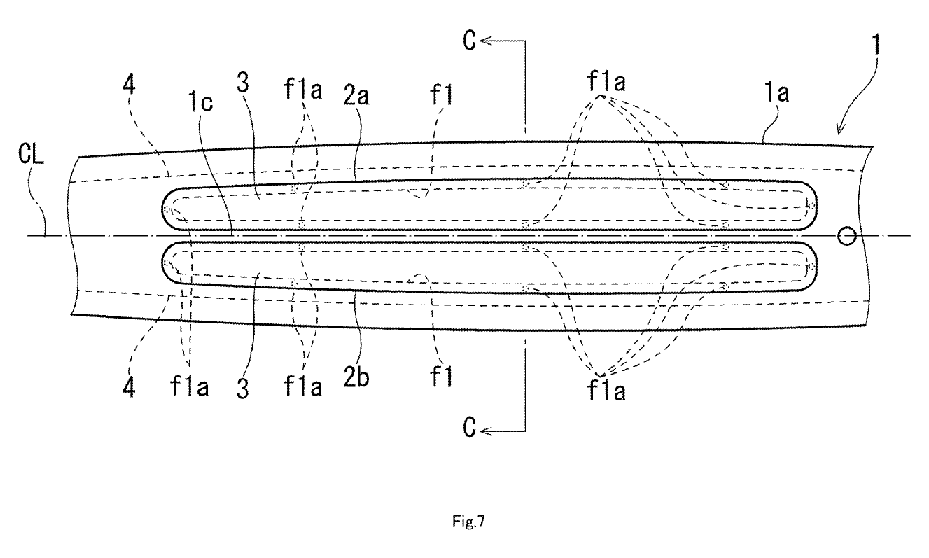

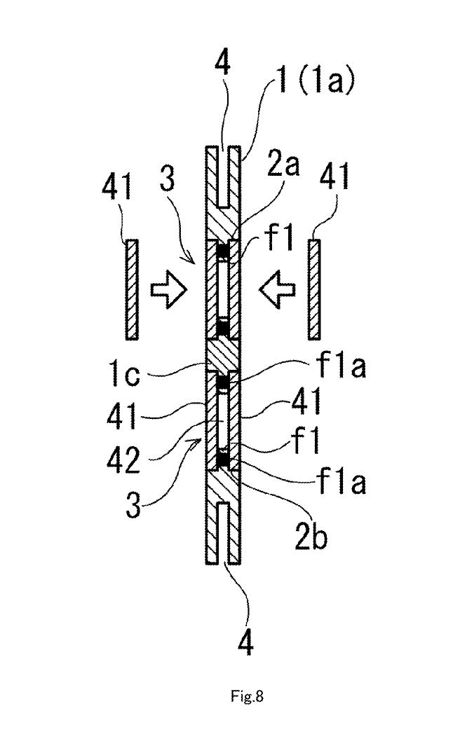

In the above guide bar, a plurality of holes may be formed through each sandwiched portion in its thickness direction, and the holes may be filled with the adhesive (see FIGS. 7 and 8, for example).

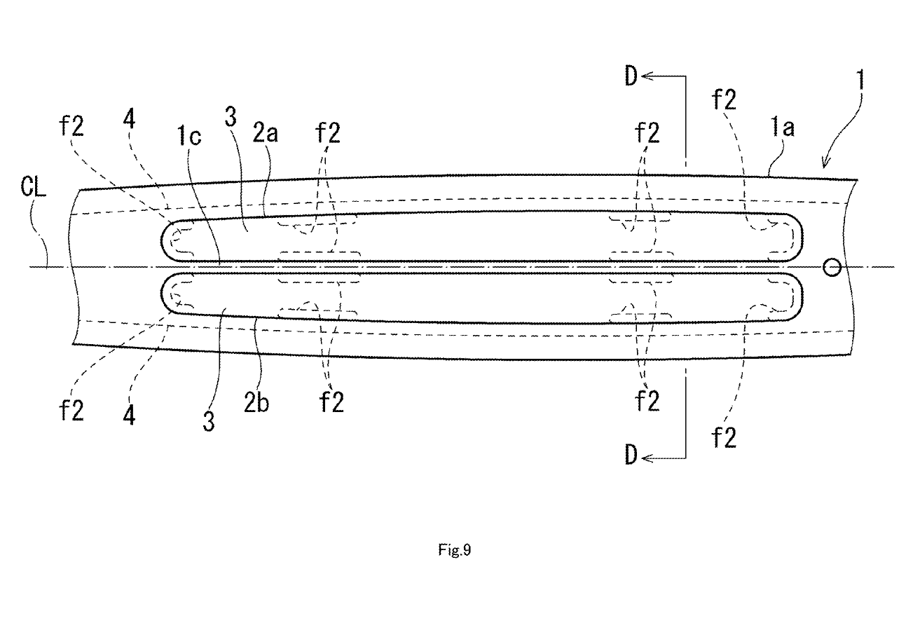

In the above guide bar, each sandwiched portion may be formed by a plurality of the projecting portions arranged at intervals in a circumferential direction of the elongated hole (see FIG. 9, for example).

In the above guide bar, the first component may be provided with a plurality of holes formed therein, which are arranged at intervals in the longitudinal direction. The second component may be provided with a plurality of protrusions formed thereon, which are fitted in the respective holes of the first component (see FIG. 5C, for example).

In the above guide bar, the first component may be provided with a plurality of holes formed therein, which are arranged at intervals in the longitudinal direction. The second component may be provided with a plurality of protrusions formed thereon, which are inserted through the respective holes of the first component such that portions of the protrusions stick out of the holes. The portions of the protrusions, which stick out of the holes, may be joined to the first component by friction stir welding (see FIG. 5D, for example).

In the above guide bar, the first component may be provided with a plurality of holes formed therein, which are arranged at intervals in the longitudinal direction. The second component may be provided with holes formed therein, which are positioned corresponding to the respective holes of the first component. The first component and the second component may be joined together by press-fitting a single shaft into each hole of the first component and press-fitting the single shaft into the corresponding hole of the second component (see FIG. 5E, for example).

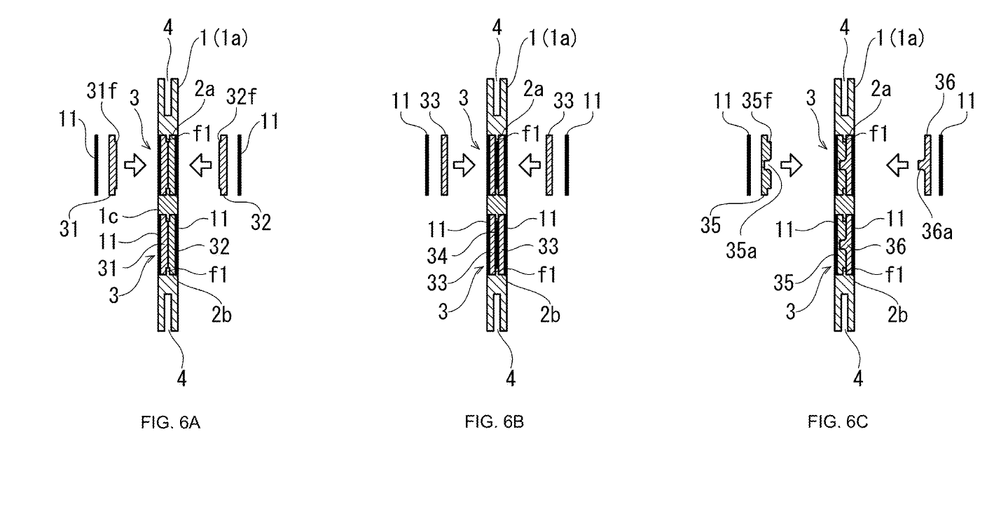

In the above guide bar, the guide bar body may include projecting portions, each of which extends inward from a side wall of a corresponding one of the elongated holes. Each attachment member may include: first and second components, between which a corresponding one of the projecting portions is sandwiched from both sides; and two pieces of sheet metal disposed outside the first and second components, respectively. The two pieces of sheet metal and opening edges of the corresponding elongated hole may be joined together by welding (see FIGS. 6A to 6C, for example).

In the above guide bar, surfaces of the first and second components, the surfaces contacting the corresponding sandwiched portion (projecting portion), may be flat, and a gap between the first and second components may be filled with an adhesive (see FIG. 6B, for example).

In the above guide bar, the first component and the second component may contact each other. A surface of the first component, the surface contacting the second component, may be provided with a recess formed therein. A surface of the second component, the surface contacting the first component, may be provided with a protrusion formed thereon, the protrusion being press-fitted in the recess (see FIG. 6C, for example).

In the above guide bar, the plurality of elongated holes may be formed such that, at each side of the region having the predetermined width and including the central axis line, one elongated hole is formed along the region having the predetermined width, and a length of the one elongated hole in the longitudinal direction may be not less than ⅓ of an overall length of the guide bar body (see FIG. 1, for example). Alternatively, the plurality of elongated holes may be formed such that, at each side of the region having the predetermined width, multiple elongated holes are formed along the region having the predetermined width, and a total length of the multiple elongated holes in the longitudinal direction may be not less than ⅓ of the overall length of the guide bar body (see FIG. 13 and FIG. 14, for example).

### Specific Configuration Examples

FIG. 1 is a front view showing one example of a guide bar of a chain saw according to the present embodiment. It should be noted that an arrow-x direction indicates the longitudinal direction of the guide bar, and an arrow-y direction indicates the width direction of the guide bar. Also, the direction perpendicular to both the arrow-x direction and the arrow-y direction (i.e., the direction perpendicular to the plane of FIG. 1) is the thickness direction of the guide bar.

The guide bar includes: an elongated plate-shaped guide bar body 1; a plurality of elongated holes 2a and 2b, which are formed through the guide bar body 1 and elongated in the longitudinal direction of the guide bar body 1; a plurality of attachment members 3, each of which is pre-formed in such a shape as to seal up a corresponding one of the elongated holes 2a and 2b and attached to the corresponding one of the elongated holes 2a and 2b.

A proximal end portion 1R of the guide bar body 1 is provided with, for example, round holes 6 and an elongated hole 7 for enabling engagement with a chain saw body (not shown) so that the proximal end portion 1R can be attached to the chain saw body. A guide groove 4 (see FIG. 2A, for example) for guiding a saw chain (not shown) is formed along the outer periphery of the guide bar body 1. That is, the saw chain is supported by the peripheral edge portion of the guide bar body 1.

In the example of FIG. 1, the guide bar body 1 is configured such that, for example, a distal end portion 1b is fixed to a body portion 1a made of a steel plate. A sprocket 5 is mounted to the distal end of the distal end portion 1b, and the distal end portion 1b is replaceable together with the sprocket 5. It should be noted that the distal end portion 1b, which includes the sprocket 5, and the body portion 1a may be integrated together. Alternatively, the distal end portion 1b and the body portion 1a may be integrated together without including the sprocket 5.

The two elongated holes 2a and 2b are formed through the guide bar body 1, and are positioned at both sides of a central axial portion 1c, which is a region having a predetermined width L3 and including a central axis line CL extending in the longitudinal direction of the guide bar body 1, such that the central axial portion 1c is positioned between the two elongated holes 2a and 2b. Thus, the elongated holes 2a and 2b are formed at both sides of the central axis line CL in such a manner that a predetermined distance (L3) is present between the elongated holes 2a and 2b, and thereby the central axial portion 1c of the guide bar body 1 is formed.

The thickness of the guide bar body 1 excluding the elongated holes 2a and 2b is uniform in a region that is indicated by a length L2 in the longitudinal direction. Thus, the thickness of the region that includes at least the central axial portion 1c and the entire peripheral portions of the respective elongated holes 2a and 2b, the entire peripheral portions serving as the side walls of the respective elongated holes 2a and 2b, is uniform. Each of the elongated holes 2a and 2b is formed such that, except their both end portions in the longitudinal direction, the distance between the outer edge of each of the elongated holes 2a and 2b and the outer peripheral edge of the guide bar body 1 is constant as indicated by distances L4 in the drawing. As a result, the section modulus of the guide bar body 1 in its elongated hole formation region, except both the end portions of each of the elongated holes 2a and 2b in the longitudinal direction, is substantially constant, which makes it possible to prevent the bending strength from varying.

Next, examples of the attachment members 3 attached to the elongated holes 2a and 2b are described. Each of FIG. 2A to FIG. 2E and FIG. 3 shows an example of the attachment members 3, and shows a sectional view taken along a line A-A of FIG. 1.

Each attachment member 3 of FIG. 2A is formed by two thin metal plates (two pieces of sheet metal) 11 and a light-weight component 12 sandwiched between the thin metal plates 11. The light-weight component 12 is made of, for example, a synthetic resin, and is formed in a shape that matches the shape of each of the elongated holes 2a and 2b. The light-weight component 12 is fitted in each of the elongated holes 2a and 2b. The metal plates 11 are each formed in a shape that matches the shape of each of the elongated holes 2a and 2b, and the metal plates 11 are fitted to each of the elongated holes 2a and 2b in such a manner that the metal plates 11 are in contact with respective opening edges on both sides of the hole. The peripheral portion of each metal plate 11 is fixed to the guide bar body 1 by laser welding or the like. For example, aluminum plates or steel plates are used as the metal plates 11. Also, as the light-weight component 12, for example, a resin member with a honeycomb structure may be used, and thereby the weight can be further reduced. Alternatively, a light metal member with a honeycomb structure may be used as the light-weight component 12.

Each attachment member 3 of FIG. 2B is formed by two thin metal plates 11 and three light-weight components 13 and 14 (two light-weight components 13 and one light-weight component 14) sandwiched between the thin metal plates 11. These light-weight components 13 and 14 are formed by light-weight members made of, for example, a resin or aluminum, and are each formed in a shape that matches the shape of each of the elongated holes 2a and 2b. The metal plates 11 are fixed to the guide bar body 1 in a manner similar to the case of FIG. 2A.

Each attachment member 3 of FIG. 2C is formed only by two thin metal plates 11, between which a void 15 is formed. The metal plates 11 are fixed in a manner similar to the case of FIG. 2A.

In the case of FIG. 2D, chamfered portions 18 are formed around the opening edges on both sides of each of the elongated holes 2a and 2b. Each attachment member 3 is formed by a light-weight component 16, which is made of, for example, a synthetic resin and formed in a shape that matches the shape of each of the elongated holes 2a and 2b. The light-weight component 16 is inserted in each of the elongated holes 2a and 2b, and these light-weight components 16 are fixed to the guide bar body 1 by an adhesive 19 applied to the chamfered portions 18.

The configuration shown in FIG. 2E is such that, in the configuration of FIG. 2D, a light-weight component 17, which is obtained by forming chamfered portions 20 on the edges of the light-weight component 16, is used as each attachment member 3. As a result, the area of the adhesion by the adhesive 19 is increased, and thereby the adhesion strength can be increased.

The left side of FIG. 3 shows the attachment members 3 and the guide bar body 1 before the attachment members 3 are attached to the guide bar body 1. The right side of FIG. 3 shows the guide bar body 1 with the attachment members 3 attached thereto. In the case of FIG. 3, each attachment member 3 is formed by the light-weight component 16, which is made of, for example, a synthetic resin and formed in a shape that matches the shape of each of the elongated holes 2a and 2b. After the light-weight components 16 are fitted in the elongated holes 2a and 2b, respectively, the light-weight components 16 and the opening edges of the elongated holes 2a and 2b are welded together by laser (i.e., laser welding), and thereby welds 37 are formed. In this manner, the attachment members 3 are fixed to the guide bar body 1.

According to the above-described configuration, regarding the number of elongated holes to be formed, it will suffice if two elongated holes 2a and 2b are formed in the guide bar body 1, and the elongated holes 2a and 2b can be formed within a short time by laser machining or press working. In this configuration, the pre-formed attachment members 3 are required to be attached to only the two elongated holes 2a and 2b. This makes it possible to reduce the manufacturing time and manufacturing cost.

Furthermore, weight reduction can be realized by using the light-weight components 12, the light-weight components 13 and 14, the light-weight components 16, or the light-weight components 17 as the attachment members 3 attached to the elongated holes 2a and 2b.

In order to realize the weight reduction, preferably, the length L2 of each of the elongated holes 2a and 2b in the longitudinal direction is not less than ⅓ of the overall length L1 of the guide bar body 1.

Each of the light-weight components 12, 13, 14, and 16 can be readily fabricated, for example, from a sheet-shaped material by performing laser cutting or punching thereon.

By using the metal plates 11 as components disposed on the outside of each attachment member 3 as shown in FIG. 2A and FIG. 2B, problems resulting from long-term use, such as breakage, detachment, abrasion, etc., of the light-weight components 12, 13, and 14, can be prevented.

Next, FIG. 4 is a front view of an essential part of the guide bar, showing a first variation of the guide bar body 1.

The guide bar body 1 shown in FIG. 4 is different from the guide bar body 1 shown in FIG. 1 in the following point: a projecting portion f1 is formed on the side wall (inner wall) of each of the elongated holes 2a and 2b along the entire periphery of the hole, the projecting portion f1 projecting inward from the side wall of the hole at its central portion in the thickness direction.

The guide bar body 1 shown in FIG. 4 is fabricated, for example, in the following manner: form through-holes by laser machining or press working through respective regions positioned inward of regions that are to be the projecting portions f1; and then form the projecting portions f1 by cutting. In this manner, the guide bar body 1 can be fabricated within a short time at low cost.

Examples of the attachment members 3 when the guide bar body 1 shown in FIG. 4 is used are described. Each of FIG. 5A to FIG. 5E and FIG. 6A to FIG. 6C shows an example of the attachment members 3, and shows a sectional view taken along a line B-B of FIG. 4.

Each attachment member 3 of FIG. 5A is formed by two light-weight components 21. The light-weight components 21 are made of, for example, a synthetic resin, and are each formed in a shape that matches the shape of each of the elongated holes 2a and 2b. An adhesive layer 22 is formed between the two light-weight components 21. The adhesive layer 22 is made of an adhesive, by which the two light-weight components 21 are adhered together. The two light-weight components 21 are brought into contact with the projecting portion f1, such that the adhesive serving as the adhesive layer 22 and the projecting portion f1 are sandwiched between the two light-weight components 21. In this manner, the two light-weight components 21 are fitted in each of the elongated holes 2a and 2b. In this case, the thickness of the adhesive layer 22 is the same as the thickness of the projecting portion f1. By setting the thickness of the projecting portion f1 to a desirable thickness of the adhesive layer 22, the thickness of the adhesive layer 22 can be made the desirable thickness.

Each attachment member 3 of FIG. 5B is formed by two light-weight components 23. The light-weight components 23 are made of, for example, a synthetic resin, and are each formed in a shape that matches the shape of each of the elongated holes 2a and 2b. An adhesive layer 24 is formed between the two light-weight components 23. The two light-weight components 23 are adhered together by the adhesive layer 24, and the adhesive layer 24 becomes elastic after being cured. The adhesive used as the adhesive layer 24 may be, for example, a rubber-based adhesive whose major component is nitrile rubber or some other synthetic rubber. In the case of FIG. 5B, the thickness of the projecting portion f1, i.e., the thickness of the adhesive layer 24, is greater than in the case of FIG. 5A. Since the adhesive layer 24 is elastic, it absorbs vibrations occurring during the use of the chain saw.

The light-weight components 21 and 23 in FIGS. 5A and 5B can be readily fabricated, for example, from a sheet-shaped material by performing laser cutting or punching thereon.

Each attachment member 3 of FIG. 5C is formed by two light-weight components 25 and 26. The light-weight components 25 and 26 are made of, for example, a synthetic resin, and are each formed in a shape that matches the shape of each of the elongated holes 2a and 2b. One light-weight component 26 is provided with a plurality of protrusions 26a, which are, for example, round protrusions and which are formed at intervals in the longitudinal direction of the guide bar body 1, such that the plurality of protrusions 26a are, for example, arranged in a plurality of regions P1 shown in FIG. 4. The other light-weight component 25 is provided with a plurality of holes 25a, in which the respective protrusions 26a are inserted. The light-weight component 25 is also provided with a recess 25f, in which the projecting portion f1 is fitted. An adhesive is applied to opposite surfaces of the two respective light-weight components 25 and 26, and the two light-weight components 25 and 26 are adhered together by the adhesive.

Each attachment member 3 of FIG. 5D is formed by two light-weight components 25 and 26. The light-weight components 25 and 26 are made of, for example, a synthetic resin, and are each formed in a shape that matches the shape of each of the elongated holes 2a and 2b. Similar to the holes 25a and the protrusions 26a of FIG. 5C, a plurality of holes 25b of one light-weight component 25 and a plurality of protrusions 26b of the other light-weight component 26 are formed at intervals in the longitudinal direction of the guide bar body 1, such that the plurality of holes 25b and the plurality of protrusions 26b are, for example, arranged in the plurality of regions P1 of FIG. 4. The protrusions 26b of the light-weight component 26 in a pre-attachment state shown in FIG. 5D protrude to a greater degree than the protrusions 26a of the light-weight component 26 shown in FIG. 5C. The holes 25b of the light-weight component 25, in which the protrusions 26b are inserted, are provided with chamfered portions 25c. In this case, when the two light-weight components 25 and 26 are placed in each of the elongated holes 2a and 2b and brought into contact with each other, the heads of the protrusions 26b stick out of the holes 25b. The sticking-out portions are subjected to friction stir welding and thereby deformed. As a result, the chamfered portions 25c are filled with the deformed portions. Consequently, the light-weight components 25 and 26 are fixed to the guide bar body 1 in such a manner that the projecting portion f1 is sandwiched between the light-weight components 25 and 26. Therefore, no adhesive is necessary.

Each attachment member 3 of FIG. 5E is formed by two light-weight components 27 and 28 and a shaft 29. The light-weight components 27 and 28 are made of, for example, a synthetic resin, and are each formed in a shape that matches the shape of each of the elongated holes 2a and 2b. The shaft 29 is made of a synthetic resin. The light-weight components 27 and 28 are provided with a plurality of holes 27a and 28a, which are, for example, round holes and which are formed at intervals in the longitudinal direction of the guide bar body 1, such that the holes 27a and 28a are, for example, arranged in the regions P1 of FIG. 4. The light-weight components 27 and 28 are also provided with recesses 27f and 28f. One half of the projecting portion f1 is fitted in the recess 27f, and the other half of the projecting portion f1 is fitted in the recess 28f. An adhesive is applied to opposite surfaces of the two respective light-weight components 27 and 28, and the two light-weight components 27 and 28 are adhered together by the adhesive. In addition, the shaft 29 is joined to the holes 27a and 28a by being press-fitted therein.

Each attachment member 3 of FIG. 6A is formed by two light-weight components 31 and 32 and two thin metal plates 11. The two light-weight components 31 and 32 are made of, for example, a synthetic resin, and are each formed in a shape that matches the shape of each of the elongated holes 2a and 2b. The light-weight components 31 and 32 are provided with recesses 31f and 32f. One half of the projecting portion f1 is fitted in the recess 31f, and the other half of the projecting portion f1 is fitted in the recess 32f The light-weight components 31 and 32 are fitted in each of the elongated holes 2a and 2b. The metal plates 11 are fixed to the guide bar body 1 in a manner similar to the case of FIG. 2A.

Each attachment member 3 of FIG. 6B is formed by two light-weight components 33 and two thin metal plates 11. The two light-weight components 33 are made of, for example, a synthetic resin, and are each formed in a shape that matches the shape of each of the elongated holes 2a and 2b. An adhesive layer 34 is formed between the two light-weight components 33. The adhesive layer 34 is made of an adhesive, by which the two light-weight components 33 are adhered together. This configuration is a result of placing the metal plates 11 on both sides in FIG. 5A. The metal plates 11 are fixed to the guide bar body 1 in a manner similar to the case of FIG. 2A.

Each attachment member 3 of FIG. 6C is formed by two light-weight components 35 and 36 and two thin metal plates 11. The two light-weight components 35 and 36 are made of, for example, a synthetic resin, and are each formed in a shape that matches the shape of each of the elongated holes 2a and 2b. One light-weight component 36 is provided with a linear protrusion 36a, which extends in the longitudinal direction of the guide bar body 1 and which is, for example, disposed in a region P2 shown in FIG. 4. The other light-weight component 35 is provided with a groove (recess) 35a, in which the protrusion 36a is press-fitted. The light-weight component 35 is also provided with a recess 35f, in which the projecting portion f1 is fitted. The two light-weight components 35 and 36 are fitted in each of the elongated holes 2a and 2b. The metal plates 11 are fixed to the guide bar body 1 in a manner similar to the case of FIG. 2A.

It should be noted that the one light-weight component 36 may be provided with not the linear protrusion 36a but, for example, a plurality of protrusions arranged in the plurality of regions P1 of FIG. 4, and the other light-weight component 35 may be provided with not the groove 35a but bottomed holes in which the plurality of respective protrusions are press-fitted.

By using the metal plates 11 as components disposed on the outside of each attachment member 3 as shown in FIG. 6A to FIG. 6C, problems resulting from long-term use, such as breakage, detachment, abrasion, etc., of the light-weight components 31, 32, 33, 35, and 36, can be prevented.

Next, FIG. 7 is a front view of an essential part of the guide bar, showing a second variation of the guide bar body 1.

The guide bar body 1 shown in FIG. 7 is different from the guide bar body 1 shown in FIG. 1 in the following points: the projecting portion f1 is formed on the side wall (inner wall) of each of the elongated holes 2a and 2b along the entire periphery of the hole, the projecting portion f1 projecting inward from the side wall of the hole at its central portion in the thickness direction; and a plurality of holes f1a are formed in the projecting portion f1, such that the holes f1a are arranged at intervals.

The guide bar body 1 shown in FIG. 7 is fabricated, for example, in the following manner: form through-holes by laser machining or press working through respective regions positioned inward of regions that are to be the projecting portions f1; and then form the projecting portions f1 and the holes f1a by cutting. In this manner, the guide bar body 1 can be fabricated within a short time at low cost.

FIG. 8 shows one example of the attachment members 3 when the guide bar body 1 shown in FIG. 7 is used, and shows a sectional view taken along a line C-C of FIG. 7.

Each attachment member 3 of FIG. 8 is formed by two light-weight components 41. The light-weight components 41 are made of, for example, a synthetic resin, and are each formed in a shape that matches the shape of each of the elongated holes 2a and 2b. In this case, each light-weight component 41 and a surface of the projecting portion f1, the surface contacting the light-weight component 41, are adhered together by an adhesive. Also, the holes f1a in the projecting portion f1 are filled with the adhesive. In this manner, the adhesion strength can be increased. A gap 42 between the two light-weight components 41 may be an empty space, or may be filled with the adhesive. By filling the gap 42 with the adhesive, the adhesion strength can be further increased.

Next, FIG. 9 is a front view of an essential part of the guide bar, showing a third variation of the guide bar body 1.

The guide bar body 1 shown in FIG. 9 is different from the guide bar body 1 shown in FIG. 1 in the following point: projecting portions f2 are formed on the side wall (inner wall) of each of the elongated holes 2a and 2b, the projecting portions f2 projecting inward from the side wall of the hole at its central portion in the thickness direction. Unlike the above-described projecting portion f1, which is formed continuously along the entire periphery of each of the elongated holes 2a and 2b, the projecting portions f2 are formed as a plurality of divided portions.

The guide bar body 1 shown in FIG. 9 is fabricated, for example, in the following manner: form through-holes by laser machining or press working through respective regions positioned inward of regions that are to be the projecting portions f2; and then form the projecting portions f2 by cutting. In this manner, the guide bar body 1 can be fabricated within a short time at low cost.

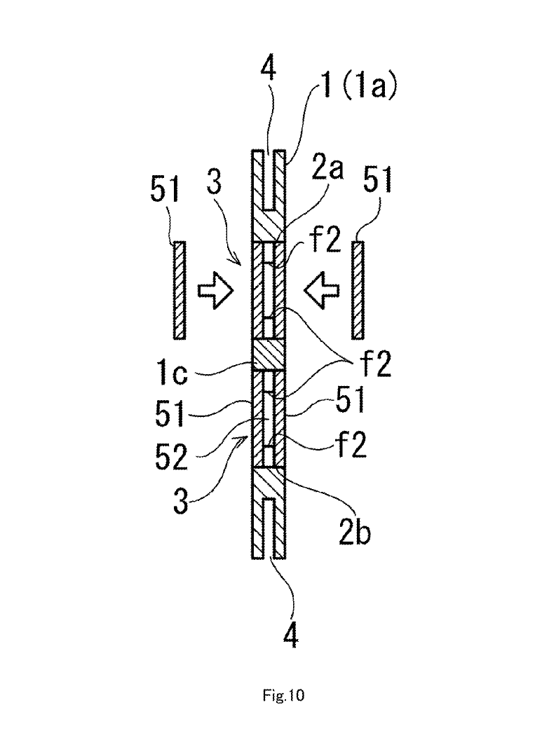

FIG. 10 shows one example of the attachment members 3 when the guide bar body 1 shown in FIG. 9 is used, and shows a sectional view taken along a line D-D of FIG. 9.

Each attachment member 3 of FIG. 10 is formed by two light-weight components 51. The light-weight components 51 are made of, for example, a synthetic resin, and are each formed in a shape that matches the shape of each of the elongated holes 2a and 2b. In this case, each light-weight component 51 and surfaces of the projecting portions f2, the surfaces contacting the light-weight component 51, are adhered together by an adhesive. A gap 52 between the two light-weight components 51 may be an empty space, or may be filled with the adhesive. By filling the gap 52 with the adhesive, the adhesion strength can be increased.

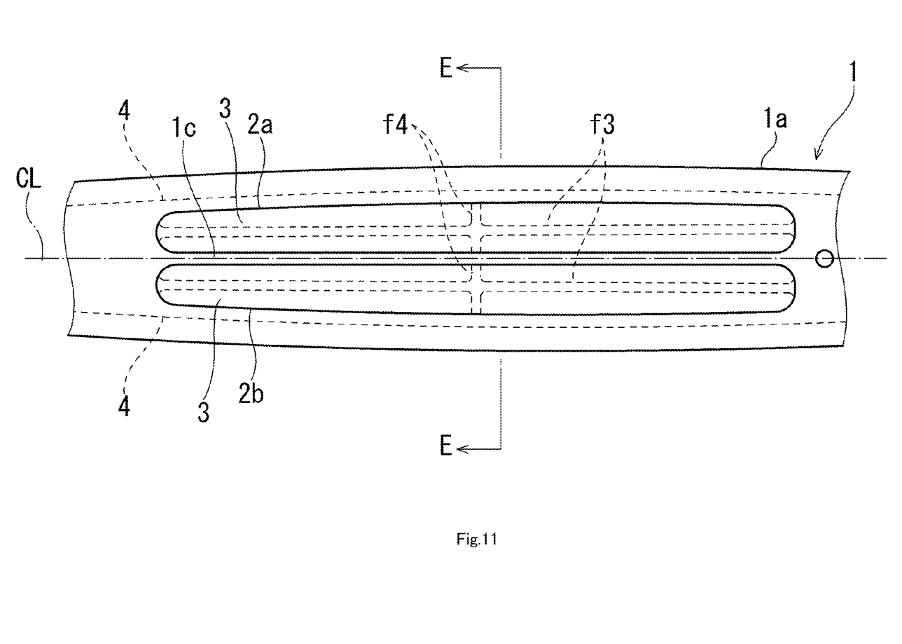

Next, FIG. 11 is a front view of an essential part of the guide bar, showing a fourth variation of the guide bar body 1.

The guide bar body 1 shown in FIG. 11 is configured such that each of the elongated holes 2a and 2b is provided with not the projecting portions f2 of FIG. 9 but a beam portion f3 extending in the longitudinal direction of the guide bar body 1 and a beam portion f4 extending in the width direction of the guide bar body 1. Each of the beam portions f3 and f4 extends from a part of the side wall (inner wall) of each of the elongated holes 2a and 2b at its central portion in the thickness direction, and connects to the opposite part of the side wall.

The guide bar body 1 shown in FIG. 11 is fabricated, for example, in the following manner: form through-holes through regions that are to be the elongated holes 2a and 2b by laser machining or press working while leaving regions that are to be the beam portions f3 and f4; and then form the beam portions f3 and f4 by cutting. In this manner, the guide bar body 1 can be fabricated within a short time at low cost.

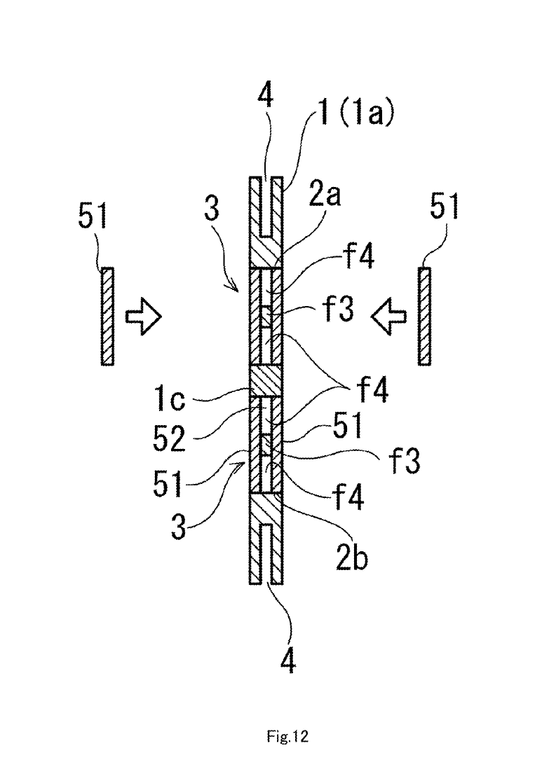

FIG. 12 shows one example of the attachment members 3 when the guide bar body 1 shown in FIG. 11 is used, and shows a sectional view taken along a line E-E of FIG. 11.

The attachment members 3 of FIG. 12 are the same as the attachment members 3 of FIG. 10. A gap 52 between the two light-weight components 51 may be an empty space, or may be filled with an adhesive. By filling the gap 52 with the adhesive, the adhesion strength can be increased.

It should be noted that holes similar to the holes f1a of FIG. 7 may be formed in the projecting portions f2 of FIG. 9 and also in the beam portions f3 and f4 of FIG. 11. These holes may be filled with an adhesive, and thereby the adhesion strength may be increased.

Next, FIG. 13 and FIG. 14 are front views of the guide bar, showing a fifth variation and a sixth variation of the guide bar body 1, respectively.

The guide bar body 1 shown in FIG. 1 is configured such that one elongated hole 2a is formed at one side, and one elongated hole 2b is formed at the other side, of the central axial portion (the region having the predetermined width L3) 1c. On the other hand, the guide bar bodies 1 shown in FIG. 13 and FIG. 14 are examples, in which a plurality of elongated holes are formed at each side of the central axial portion 1c, such that the plurality of elongated holes are arranged in the longitudinal direction of the guide bar body 1 along the central axial portion 1c.

Specifically, the guide bar body 1 shown in FIG. 13 is configured such that two elongated holes 2aA and 2aB are formed at one side, and two elongated holes 2bA and 2bB are formed at the other side, of the central axial portion 1c. Attachment members 3A and 3B are attached to these elongated holes. Those similar to the attachment members 3 of the guide bar body 1 shown in FIG. 1 can be used as the attachment members 3A and 3B.

In order to reduce the weight of the guide bar of the guide bar body 1 shown in FIG. 13, preferably, the total length of the elongated holes (2aA and 2aB; or 2bA and 2bB) in the longitudinal direction (i.e., L2A+L2B) is not less than ⅓ of the overall length L1 of the guide bar body 1.

The guide bar body 1 shown in FIG. 14 is configured such that three elongated holes 2aC, 2aD, and 2aE are formed at one side, and three elongated holes 2bC, 2bD, and 2bE are formed at the other side, of the central axial portion 1c. Attachment members 3C, 3D, and 3E are attached to these elongated holes. Those similar to the attachment members 3 of the guide bar body 1 shown in FIG. 1 can be used as the attachment members 3C, 3D, and 3E.

In order to reduce the weight of the guide bar of the guide bar body 1 shown in FIG. 14, preferably, the total length of the elongated holes (2aC, 2aD, and 2aE; or 2bC, 2bD, and 2bE) in the longitudinal direction (i.e., L2C+L2D+L2E) is not less than ⅓ of the overall length L1 of the guide bar body 1.

It should be noted that each of the elongated holes (2aA, 2aB, 2bA, and 2bB) shown in FIG. 13 and each of the elongated holes (2aC, 2aD, 2aE, 2bC, 2bD, and 2bE) shown in FIG. 14 may be provided with a projecting portion (f1), projecting portions (f2), or beam portions (f3 and f4) as previously described in the first to fourth variations, and an attachment member suited thereto may be attached to each elongated hole.

As described above with reference to FIG. 1, FIG. 4, FIG. 7, FIG. 9, FIG. 11, FIG. 13, and FIG. 14, by forming the elongated holes (2a and 2b; 2aA, 2aB, 2bA and 2bB; or 2aC, 2aD, 2aE, 2bC, 2bD, and 2bE) in the guide bar body 1 while leaving the central axial portion 1c including the central axis line CL, reduction in the strength of the guide bar, such as reduction in the bending strength, can be suppressed.

The guide bar bodies 1 shown in FIG. 1, FIG. 4, FIG. 7, FIG. 9, FIG. 11, FIG. 13, and FIG. 14 may be suitably combined with the above-described various attachment members 3. For example, also in the case of using any of the guide bar bodies 1 shown in FIG. 7, FIG. 9, and FIG. 11, the metal plates 11 may be used as components disposed on the outside, at both sides, of each attachment member 3.

From the foregoing description, numerous modifications and other embodiments of the present invention are obvious to a person skilled in the art. Therefore, the foregoing description should be interpreted only as an example and is provided for the purpose of teaching the best mode for carrying out the present invention to a person skilled in the art. The structural and/or functional details may be substantially altered without departing from the spirit of the present invention.

### INDUSTRIAL APPLICABILITY

The present invention is useful as, for example, a guide bar of a chain saw with a reduced weight, the guide bar making it possible to reduce its manufacturing time and manufacturing cost.

### REFERENCE CHARACTER LIST

CL central axis line
1 guide bar body
1c central axial portion (region having a predetermined width)
2a, 2b elongated hole
2aA, 2aB, 2bA, 2bB elongated hole
2aC, 2aD, 2aE, 2bC, 2bD, 2bE elongated hole
3, 3A, 3B, 3C, 3D, 3E attachment member
4 guide groove
11 metal plate (sheet metal)
12, 13, 14, 16, 17 light-weight component
18, 20 chamfered portion
19 adhesive
21, 23, 25, 26, 27, 28 light-weight component
22, 24 adhesive layer
25a, 25b, 27a, 28a hole
26a, 26b protrusion
29 shaft
31, 32, 33, 35, 36, 41, 51 light-weight component
34 adhesive layer
35a groove (recess)
36a protrusion
f1, f2 projecting portion
f1a hole in the projecting portion
f3, f4 beam portion

1. A guide bar of a chain saw, the guide bar comprising:
an elongated plate-shaped guide bar body that supports a saw chain on its peripheral edge portion;
a plurality of elongated holes formed through the guide bar body and positioned at both sides of a region that has a predetermined width and includes a central axis line extending in a longitudinal direction of the guide bar body, such that the region is positioned between the elongated holes, which are elongated in the longitudinal direction; and
a plurality of attachment members, each of which is pre-formed in such a shape as to seal up a corresponding one of the elongated holes and attached to the corresponding elongated hole.

2. The guide bar of a chain saw according to claim 1, wherein
the attachment members are fitted in the elongated holes, and each attachment member is joined to opening edges of the corresponding elongated hole.

3. The guide bar of a chain saw according to claim 2, wherein
each attachment member includes two pieces of sheet metal that are disposed at both ends of the corresponding elongated hole in a thickness direction of the guide bar body, and
the two pieces of sheet metal and the opening edges of the elongated hole are joined together by welding.

4. The guide bar of a chain saw according to claim 3, wherein
each attachment member further includes one or more components disposed between the two pieces of sheet metal, the one or more components each having a shape that is the same as a cross-sectional shape of the corresponding elongated hole.

5. The guide bar of a chain saw according to claim 2, wherein
chamfered portions are:
formed on portions of each attachment member, the portions contacting the opening edges of the corresponding elongated hole; and/or
formed on the opening edges of the elongated hole, and
each attachment member and the opening edges of the corresponding elongated hole are jointed together by filling the chamfered portions with an adhesive.

6. The guide bar of a chain saw according to claim 2, wherein
each attachment member is formed by a single component having a shape that is the same as a cross-sectional shape of the corresponding elongated hole, and
the single component is fitted in the elongated hole, and the single component and the opening edges of the elongated hole are joined together by laser welding.

7. The guide bar of a chain saw according to claim 1, wherein
the guide bar body includes sandwiched portions, each of which is formed by either a projecting portion or a beam portion, the projecting portion extending inward from a side wall of each elongated hole, the beam portion connecting between opposite parts of the side wall of the elongated hole, and
each attachment member includes first and second components, between which a corresponding one of the sandwiched portions is sandwiched from both sides.

8. The guide bar of a chain saw according to claim 7, wherein
surfaces of the first and second components, the surfaces contacting the corresponding sandwiched portion, are flat, and
a gap between the first and second components is filled with an adhesive.

9. The guide bar of a chain saw according to claim 8, wherein
a plurality of holes are formed through each sandwiched portion in its thickness direction, and
the holes are filled with the adhesive.

10. The guide bar of a chain saw according to claim 7, wherein
each sandwiched portion is formed by a plurality of the projecting portions arranged at intervals in a circumferential direction of the elongated hole.

11. The guide bar of a chain saw according to claim 7, wherein
the first component is provided with a plurality of holes formed therein, which are arranged at intervals in the longitudinal direction, and
the second component is provided with a plurality of protrusions formed thereon, which are fitted in the respective holes of the first component.

12. The guide bar of a chain saw according to claim 7, wherein
the first component is provided with a plurality of holes formed therein, which are arranged at intervals in the longitudinal direction,
the second component is provided with a plurality of protrusions formed thereon, which are inserted through the respective holes of the first component such that portions of the protrusions stick out of the holes, and
the portions of the protrusions, which stick out of the holes, are joined to the first component by friction stir welding.

13. The guide bar of a chain saw according to claim 7, wherein
the first component is provided with a plurality of holes formed therein, which are arranged at intervals in the longitudinal direction,
the second component is provided with holes formed therein, which are positioned corresponding to the respective holes of the first component, and
the first component and the second component are joined together by press-fitting a single shaft into each hole of the first component and press-fitting the single shaft into the corresponding hole of the second component.

14. The guide bar of a chain saw according to claim 1, wherein
the guide bar body includes projecting portions, each of which extends inward from a side wall of a corresponding one of the elongated holes,
each attachment member includes:
first and second components, between which a corresponding one of the projecting portions is sandwiched from both sides; and
two pieces of sheet metal disposed outside the first and second components, respectively, and
the two pieces of sheet metal and opening edges of the corresponding elongated hole are joined together by welding.

15. The guide bar of a chain saw according to claim 14, wherein
surfaces of the first and second components, the surfaces contacting the corresponding sandwiched portion, are flat, and
a gap between the first and second components is filled with an adhesive.

16. The guide bar of a chain saw according to claim 14, wherein
the first component and the second component contact each other,
a surface of the first component, the surface contacting the second component, is provided with a recess formed therein, and
a surface of the second component, the surface contacting the first component, is provided with a protrusion formed thereon, the protrusion being press-fitted in the recess.

17. The guide bar of a chain saw according to claim 1, wherein
the plurality of elongated holes are formed such that, at each side of the region having the predetermined width and including the central axis line, one or more elongated holes are formed along the region having the predetermined width, and
a total length of the one or more elongated holes in the longitudinal direction is not less than ⅓ of an overall length of the guide bar body.
